(19) United States
(12) Patent Application Publication
(10) Pub. No.: US 2008/0172578 A1
(43) Pub. Date: Jul. 17, 2008

(54) Detection device capable of detecting main-board and method therefor

(75) Inventor: Sheng-Yuan Tsai, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/652,129

(22) Filed: Jan. 11, 2007

(51) Int. Cl. G06F 11/22

(52) U.S. Cl. 714/36; 714/E11.149

(57) ABSTRACT

A detection device and a method therefor are provided. The detection device is used to activate the main-board, when the power-on interval of the main-board is equal to the predetermined power-on interval. The detection device compares the value of the status signal transmitted with the predetermined status value. In case that the two values are not equal, the detection device generates and displays a first error message; otherwise, in case that the two values are equal, then the detection device powers-off the main-board, and upon determining that the voltage after its power-off is not equal to zero voltage, the detection device generates and displays a second error message; and upon determining that the accumulated detection number is not equal to the predetermined detection number, the detection device will reactivate the main-board and repeats the above steps, after the power-off interval of the main-board has reached to the predetermined power-off interval.

### BACKGROUND

1. Field of Invention

The invention relates to a detection device capable of detecting a main-board and a method of detecting the same, and in particular to a detection device capable of detecting the status of the main-board through repeatedly powering on/powering off the main-board and a method of detecting the same.

2. Related Art

In general, in a complicated electronic system (for example, a computer), the main-board is a unique and the most important circuit board Thus, for the normal operation of the system, it is essential that the main-board must function correctly and accurately.

In order to make sure that a main-board is capable of functioning normally, a series of tests are performed on a main-board after it is manufactured. Among them, a power-on/power-off test is performed to test whether the main-board is capable of continuing to function normally, if various conditions develop during the power-on/power-off test. For example, shutting down the power supply to the main-board before it completes a power-on process to test and determine if the main-board can function normally in the next power-on process; or repeatedly powering on/powering off the main-board to determine if it can perform and complete normally each of the respective power-on/power-off processes.

Usually, the power-on/power-off of a main-board is initiated through manually pressing on a power-switch button for generating a power-on/power-off signal to be sent to the main-board, thus activating the main-board in performing the related power-on/power-off operations. However, in this manner, during a test process, it is required to generate a power-on/power-off signal repeatedly, yet in practice, it is not feasible to manually press the power-switch button repeatedly for carrying on the test. In addition, recently, the standard for the main-board test is getting stricter, and the demands for test preciseness are getting stronger. Therefore, presently, a kind of test machine is developed, that is mainly used to test if the power-on/power-off of a main-board is normal. This kind of test machine mainly composed of a computer and a test module. Upon connecting the test module to the main-board, the testing of main-board power-on/power-off operation is controlled through a software in a computer. Through the utilization of this kind of test machine, the problems caused by the unreliable and inaccurate manual operation of the power-switch button can be solved.

However, the test machine still has the problems of voluminous size, inconvenient to carry, difficult to maintain and repair, high production cost, and high power consumption. In addition, this kind of test machine is not capable of detecting if a main-board has been powered on/powered off correctly, thus creating the problem of misjudging the results of the subsequent power-on/power-off operations. Therefore, the design and development of a test machine, that is portable, easy to carry, and capable of testing if a main-board is powered on/powered off normally and correctly, is one of the most urgent tasks that must be solved in this field.

### SUMMARY OF THE INVENTION

In view of the above-mentioned problems and drawbacks of the prior art, the object of the invention is to provide a detection device capable of detecting a main-board through repeatedly powering on/powering off the main-board, and a method of detecting the same. During the operation of the invention, a power-on/power-off signal is sent to a main-board from a detection device for testing the capability of the main-board to be powered on/powered off correctly and repeatedly.

The device of the invention is composed of only three major components: a processing circuit of lower consumption, a simple-structured input device and a display device, thus making its size compact and easy and convenient to carry. In addition, the processing circuit can be self-designed by users, and the various elements of the processing circuit are readily available, hereby solving the problem of high cost and difficult maintenance of the prior art. Since the processing circuit can be self-designed by the user, thus the device and method of the invention may readily be designed to have the capability of detecting if the main-board may fully and completely perform the functions of the power-on/power-off operations.

To achieve the above-mentioned object, the invention can be implemented by a detection device and a method therefor. In the invention, the detection device includes: an input device, a processing circuit, and a display device. Moreover, the method disclosed by the invention includes the following steps: firstly, setting a predetermined status value in a detection device; next, coupling the detection device to a main-board; then, receiving by the detection device a detection number, a power-on interval, and a power-off interval; subsequently, activating the main-board by the detection device and start counting the time, meanwhile, receiving a status signal transmitted from the main-board; then, determining by the detection device if the activation interval of the main-board has reached the power-on interval, and comparing the value of the status signal with the predetermined status value to see if they are equal. If the answer is affirmative, powering off the main-board and calculating the accumulated detection number, otherwise, generating and displaying a first error message; subsequently, upon detecting by the detection device that the voltage transmitted from the main-board is not equal to zero voltage, generating and displaying a second error message; finally, upon determining by the detection device that the shut-down interval of the main-board has reached the power-off interval, then reactivating the main-board, until the accumulated detection number is equal to the detection number.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus is not limitative of the invention, and wherein:

FIG. 1 is a system block diagram of a detection device capable of detecting the status of a main-board through repeatedly powering on/powering off the main-board according to an embodiment of the invention;

FIG. 2A is a flowchart of the steps of a detection method capable of detecting the status of a main-board through repeatedly powering on/powering off the main-board according to an embodiment of the invention; and

FIG. 2B is a flowchart of the steps of the process of testing the main-board by the processing circuit according to an embodiment of the invention.

### DETAILED DESCRIPTION OF THE INVENTION

The purpose, construction, features, and functions of the invention can be appreciated and understood more thoroughly through the following detailed description with reference to the attached drawings.

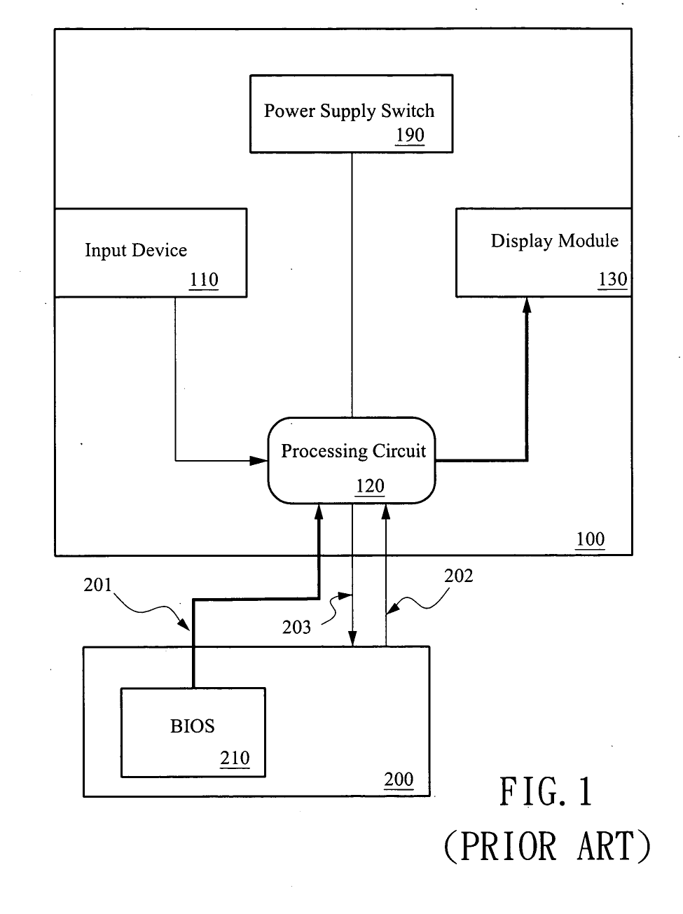

Firstly, the various components of the detection device shown in FIG. 1 used for detecting a main-board through repeatedly powering on/powering off the main-board are described in explaining the operation of the invention. As shown in FIG. 1, the detection device 100 of the invention includes an input device 110, a processing circuit 120, and a display device 130.Wherein, the input device 110 is coupled to the processing circuit 120, and is used to input a detection number, a power-on interval and a power-off interval; the processing circuit 120 is coupled to input device 110 and main-board 200, and is used to store a status value as a predetermined status value, that is output after a Power On Self Test (POST) is performed by a Basic Input/Output System (BIOS) located on the main-board, and that is used to transmit a power-on signal to main-board 200 when the time duration after the powering off of the main-board 200 is equal to a power-off interval; and is used to receive a status signal transmitted from main-board 200; moreover, it is used to determine the value of the status signal, when the power-on time duration of main-board 200 is equal to a power-on interval; when the value of the status signal is not equal to the predetermined status value, generating a first error message; and when the value of the status signal is equal to the predetermined status value, generating a power-off signal to the main-board 200 to make it power-off; furthermore, upon determining that the voltage transmitted from main-board 200 is not equal to zero voltage, generating a second error signal; and when the number of times of transmitting the power-on signal is not equal to the detection number, retransmitting a power-on signal to main-board 200 after the power-off interval is finished. The display device 130 is coupled to the processing circuit 120, and is used to display the first error message and the second error message.

In the following, a preferred embodiment is described to explain the device and method of the invention. In the present embodiment, a dip switch is utilized as an example for the input device 110, however, the input device of the invention is not limited to this. Also, in the present embodiment, a seven-segment display is used as an example for the display device, however, the display device of the invention is not limited to this, other well known display device capable of displaying numbers and characters, such as liquid crystal display (LCD) may also be used in the invention.

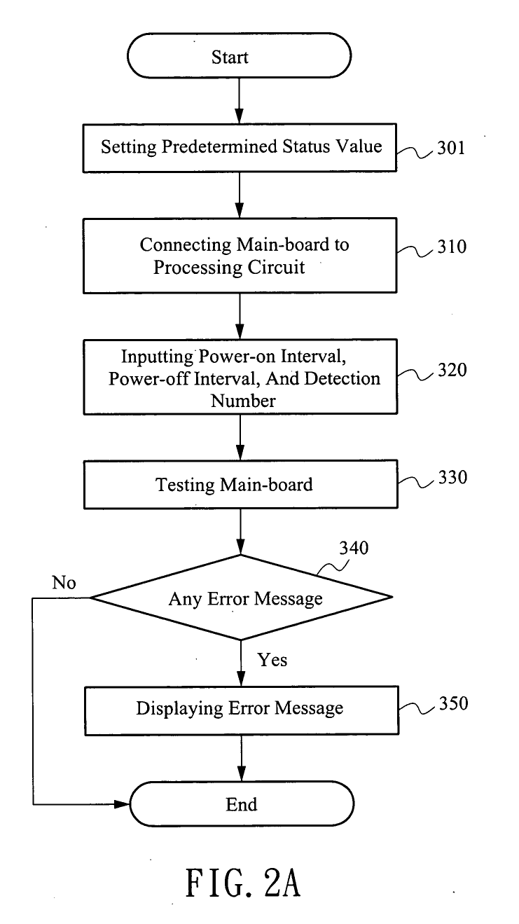

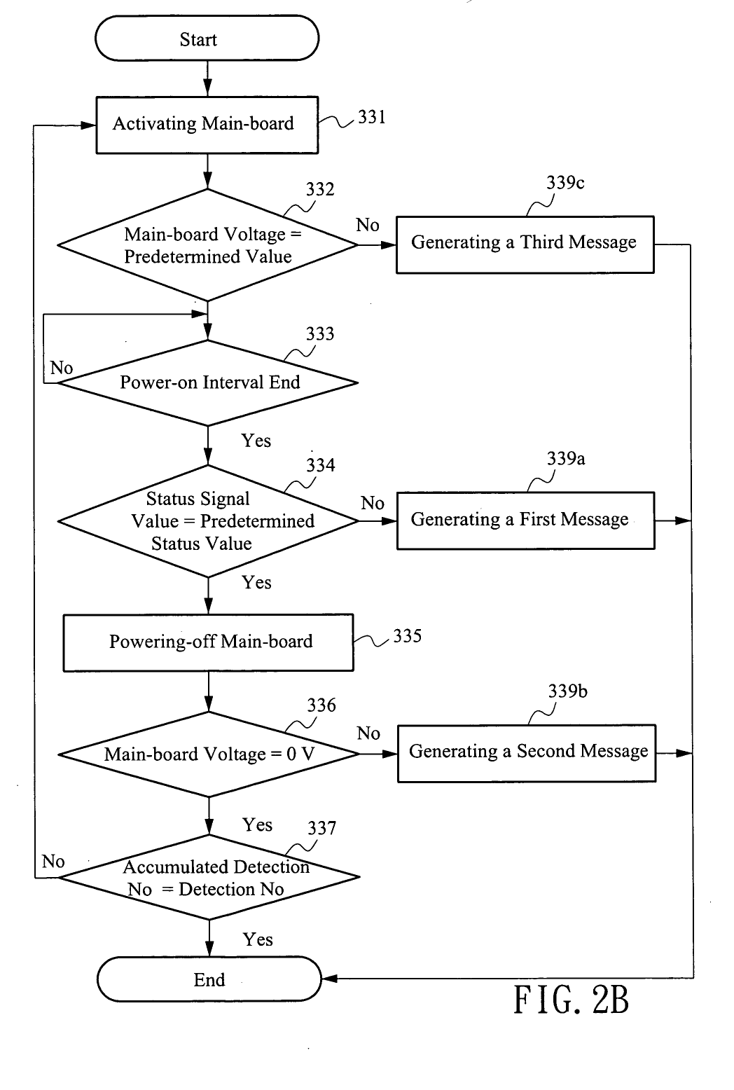

Refer to FIG. 2A for a flowchart of a method of repeatedly powering on/powering off in detecting a main-board according to an embodiment of the invention. As shown in FIG. 2A, before proceeding with the execution of the detection device 100 of the invention, the detection device must first be set to a predetermined status value (step 301), that can be realized through inputting to processing circuit 120 by means of an input device 110, or through storing the predetermined status value directly into processing circuit 120. Next, the main-board 200 is connected to the detection device 100 of the invention (step 310). Wherein, a BIOS 210 on the main-board 200 must be connected to the processing circuit 120, thus being able to transmit a signal indicating the power-on status of main-board 200. Processing circuit 120 is also connected to main-board 200 through three additional signal lines: the first signal line 201 is used to transmit a power-on signal and a power-off signal, the second signal line 202 is used to transmit a voltage indicating the power-on status of main-board 200, and the third signal line 203 is used to transmit power-on/power-off signals.

Upon finishing the connection between main-board 200 and detection device 100 of the invention, the user may proceed with the testing required. Firstly, dip switch is used to input sequentially the power-on interval, the power-off interval, and the detection number (step 320), and the processing circuit 120 will consider the signals received as the power-on interval, the power-off interval, and detection number based on their sequence, however, the invention is not limited to this. For example, an additional dip switch may be used to input and set a particular one of the power-on interval, the power-off interval, and the detection number. Then, the processing circuit 120 may update the corresponding power-on interval, power-off interval, and detection number based on the settings of the input signals.

Subsequently, upon finishing inputting the power-on interval, the power-off interval, and the detection number, the processing circuit 120 may start testing the main-board (step 330), the details of the test processes will be described later. In case that an error occurs in the test process (step 340), then processing circuit 120 will stop testing and transmit an error message corresponding to the error occurred to a seven-segment display, and display it to the user for reference (step 350).

Now, we are going to describe in detail the process of testing the main-board as performed by the processing circuit (step 330). Refer to FIG. 2B for a flowchart of a method of repeatedly powering on/powering off in detecting a main-board according to an embodiment of the invention. As shown in FIG. 2B, as the processing circuit 120 starts testing a main-board, it will determine the status of the main-board 200 based on the voltage on the second signal line 202. If at this time, the voltage on the second signal line 202 is equal to zero voltage, then it is determined that main-board 200 is in a power-off state, thus the processing circuit 120 will transmit a power-on signal to the main-board 200 through a third signal line 203. Upon receiving the power-on signal, the main-board 200 will proceed with the power-on procedures required (step 331). Otherwise, if at this time, the voltage on the second signal line 202 is not equal to zero voltage, then it is determined that main-board 200 is in a power-on state, thus the processing circuit 120 will transmit a power-off signal to the main-board 200 to power-off main-board 200 (step 335).

In the process of executing the power-on procedure by the main-board 200, a BIOS 210 will first perform a POST to test if the various peripheral devices on main-board 200 are functioning normally. In this process, before the a BIOS 210 starts testing a certain peripheral device, it will transmit a status signal to processing circuit 120 via a first signal line 201 indicating what kind of peripheral test is to be performed at this time.

Meanwhile, the processing circuit 120 will calculate the time required for transmitting the power-on signal to the main-board 200. If the time interval thus calculated by the processing circuit 120 is equal to the power-on interval input in step 320 (step 333), then processing circuit 120 will compare the value of the status signal last transmitted from BIOS 210 with predetermined status value (step 334), and if the value of the status signal last transmitted from BIOS 210 is the same as the predetermined status value, that indicates that all is fine and normal with the power-on process of main-board 200, and the processing circuit 120 will increment the accumulated detection number by 1.

Meanwhile, processing circuit 120 will transmit a power-off signal to main-board 200 through a third signal line 203, and start calculating the time required for the power-off signal to be transmitted to main-board 200 (step 335), hereby powering-off main-board 200 to complete the test of this time. However, if the value of the status signal transmitted from BIOS 210 to processing circuit 120 is not the same as the predetermined status value, then processing circuit 120 will generate a first error message such as “power-on failure” (step 339a), and transmit it to a seven-segment display for display (step 340, step 350), and will subsequently end the test. In order for the user to understand more clearly that the status of a particular step in the main-board 200 power-on process is in error, the processing circuit 120 may transmit the status signal that caused the generation of the first error message to the seven-segment display for display. Upon receiving a power-off signal transmitted from the processing circuit 120, the main-board 200 will execute the power-off procedure to power itself off (step 335). Then, the processing circuit 120 will check the voltage of main-board 200 after the power-off of main-board 200 (step 336), if the voltage is not equal to zero voltage, that indicates that the power-off of main-board 200 is a failure, namely, main-board 200 is still in a power-on state.

Therefore, the processing circuit 120 will generate a second error message such as “power-off failure” (step 339b), and transmit it to a display module 130 to display (step 350), and will thus terminate all the subsequent tests.

However, on the other hand, if the voltage of main-board 200 is equal to zero after executing the power-off of main-board 200, that means that main-board 200 has been powered-off successfully, then the processing circuit 120 will determine if the accumulated detection number is the same as the detection number input in step 320 (step 337). If the answer is affirmative, that indicates that the all the tests for main-board 200 are completed, and there is no need to proceed with any further tests.

Otherwise, if the answer is negative, that indicates that the tests of main-board 200 have not yet finished, then it has to wait until the time required for a power-off signal to be transmitted from processing circuit 120 to the main-board 200 as calculated by the processing circuit 120 is equal to the power-off interval input in step 320, and then a power-on signal is transmitted to main-board 200 from processing circuit 120 via a third signal line 203 (step 331) to proceed with the subsequent test of main-board 200. Thus, in this manner, the main-board 200 again executes the power-on procedure, and the processing circuit 120 again repeats step 331 to step 337 to proceed with the testing of main-board 200 to determine that if it can be powered-on/powered-off normally. As such, the invention provides a method of detection to determine if the power-on/power-off functions of main-board is normal, thus solving the problem and shortcomings of the prior art.

In the above-mentioned test flow, after the step of transmitting a power-on signal from a processing circuit 120 to a main-board 200 (step 331), a step of determining the voltage of main-board 200 can be added (step 332), thus it may know more quickly that if main-board 200 may enter into a power-on procedure. In case that the voltage value is equal to the predetermined value, namely, the value of the voltage transmitted from main-board 200 to processing circuit 120 is the same as the operation voltage of main-board 200, then start calculating the time (step 333); otherwise, in case that the value of the voltage is not equal to the predetermined value, that indicates that the main-board 200 can not enter into the power-on procedure normally. Thus, the processing circuit 120 will generate a third error message such as “normal power-on impossible” (step 339c), and transmit it to a display module 130 for display, and meanwhile terminate all the subsequent tests.

In addition, the detecting device 100 of the invention may further includes a power supply switch 190, that is used to switch the power supplied to the main-board 200 from direct current (DC) to alternate current (AC) or vice versa according to the power supply switching signal transmitted from the processing circuit 120, thus the main-board 200 may execute the above-mentioned power-on process by utilizing the DC or AC output from the power supply switch 190. As such, while inputting the parameters such as power-on interval, power-off interval, and detection number (step 320), the user may further input a power supply switching interval, so that in the process of testing main-board (step 330), in case that the time interval calculated by the processing circuit 120 is equal to this power supply switching interval, then a power supply switching signal is transmitted from the processing circuit 120 to the power supply switch 190.

Upon receiving this power supply switching signal, and in case that at this time the power supplied to the main-board 200 is in the form of DC, then the power supply switch will stop outputting DC current and switch to outputting AC current; otherwise, in case that at this time the power supplied to the main-board 200 is in the form of AC, then it is switched to the form of DC, thus realizing the testing of the main-board in determining that if it can maintain normal operation in the power-on process even if during which the form of power supply is switched from AC to DC or vice versa.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A detection device capable of detecting a main-board through powering on/powering off said main-board repeatedly, comprising:
an input device, used to input parameters of a detection number, a power-on interval, and a power-off interval;
a processing circuit, coupled to said input device and said main-board, and is used to store a predetermined status value, and transmit a power-on signal to and activate said main-board and calculate a time, and at the same time receive a status signal from said main-board, and when said main-board's detection interval reaches said power-on interval, compare a value of said status signal with said predetermined status value, and in case that said value of said status signal is not equal to said predetermined status value, generate a first error message; and in case that said value of said status signal is equal to said predetermined status value, then transmit a power-off signal to said main-board to power-off said main-board and calculate an accumulated detection number, meanwhile determine and verify that if a voltage transmitted from said main-board is not equal to zero voltage, then generate a second error message; and when said accumulated detection number is not equal to said detection number, determine power-off interval of said main-board, and when said power-off interval of said main-board reaches said power-off interval, reactivate said main-board; and
a display device, coupled to said processing circuit, and is used to display said first error message and said second error message.

2. The detection device as claimed in claim 1, wherein said input device is a dip switch.

3. The detection device as claimed in claim 1, wherein said processing circuit has a predetermined voltage stored therein, that is used to activate said main-board, and then determine that if said voltage transmitted from said main-board is different from said predetermined voltage, then generate a third error message.

4. The detection device as claimed in claim 3, wherein said display device is used to display said third error message.

5. The detection device as claimed in claim 1, wherein said display device is used to display said accumulated detection number.

6. The detection device as claimed in claim 1, wherein said display device is a seven-segment display.

7. The detection device as claimed in claim 1, wherein said display device is a liquid crystal display (LCD).

8. The detection device as claimed in claim 1, wherein said detection device further includes a power switch, coupled to said processing circuit and said main-board, and is used to receive a power supply switching signal transmitted from said processing circuit based on a power supply switching interval input through said input device, and switch power supply output to said main-board from alternate current (AC) to direct current (DC) or vice versa according to said power supply switching signal.

9. A detection method capable of detecting a main-board through powering on powering off said main-board repeatedly, comprising the following steps:
(a). providing a predetermined status value in a detection device;
(b). coupling said detection device to said main-board;
(c). receiving a detection number, a power-on interval, and a power-off interval by said test device;
(d). activating said main-board and calculating the time by said detection device, and receiving a status signal transmitted back from said main-board at the same time;
(e). when determining that activation interval of said main-board has reached to said power-on interval, said detection device compares value of said status signal with said predetermined status value, and when said value of said status signal is equal to said predetermined status value, powers-off said main-board and calculates a time, meanwhile calculates an accumulated detection number;
(f). upon determining that voltage transmitted from said main-board is not equal to zero voltage, said detection device generates and displays a first error message; and
(g). upon determining that power-off interval of said main-board has reached to said power-off interval, said detection device repeats step (d) to step (g), until said accumulated detection number is equal to said detection number,
wherein, when said value of said status signal is not equal to said predetermined status value, said detection device generates and displays a second error message.

10. The detection method as claimed in claim 9, wherein said method includes the following steps:
providing a predetermining voltage value in said detection device; and
upon transmitting said power-on signal and then determining that voltage value transmitted from said main-board is not equal to said predetermined voltage value, said detection device generates a third error message.
